(19) United States
(12) Patent Application Publication
(10) Pub. No.: US 2015/0058761 A1
(43) Pub. Date: Feb. 26, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventors: Hainan Cai, Beijing (CN); Zhiming Meng, Beijing (CN); Zhiyi Cai, Beijing (CN); Xuejin Wang, Beijing (CN); Yonggui Wu, Beijing (CN); Yidong Liu, Beijing (CN)

(73) Assignees: Lenovo (Beijing) Co., Ltd., Beijing (CN); Beijing Lenovo Software Ltd., Beijing (CN)

(21) Appl. No.: 14/229,932

(22) Filed: Mar. 30, 2014

(30) Foreign Application Priority Data
Aug. 26, 2013 (CN) 201310376383.8

(51) Int. Cl. G06F 3/0481; G06F 3/0488; G06F 3/0484

(52) U.S. Cl. CPC G06F 3/04817; G06F 3/04842; G06F 3/0488
USPC 715/763

(57) ABSTRACT

The present invention relates to the field of human-machine interactions and discloses an information processing method and an electronic device so as to address the technical problems in the convention that it may be time-consuming for the electronic device to receive an entry operation and the electronic device may respond to an improper entry operation. The method is applicable to an electronic device with a display unit on which there are displayed N target objects, wherein N is a positive integer, there is a display parameter for each of the target objects, there is an initial value for the display parameter of each of the target objects, and the display parameter is configured to determine a display size of the target object, and wherein the method includes: determining M target objects and K target objects among the N target objects according to a preset rule.

The present application claims the priority of Chinese Patent Application No. 201310376383.8, entitled as “Information processing method and electronic device”, and filed with the Chinese Patent Office on Aug. 26, 2013, the contents of which are incorporated herein by reference in its entirety.

### FIELD OF THE INVENTION

The present invention relates to the field of human-machine interactions and in particular to an information processing method and an electronic device.

### BACKGROUND OF THE INVENTION

Along with constant development of sciences and technologies, electronic technologies have been rapidly developed, and more and more types of electronic products have emerged, so people have enjoyed numerous conveniences as a result of the development of sciences and technologies. Now people can enjoy their conformable life brought by the development of sciences and technologies through using the various electronic products.

In the convention, an electronic device can be controlled by numerous input apparatuses, and in order to save a space in which the electronic device is manufactured or in order to ensure entry security, the electronic device is typically configured with N target objects, and for some compact electronic device (e.g., a handset), a user can hold the handset conveniently with his or her single hand and perform an entry operation on the N target objects with the same hand as the single holding hand.

The inventors of this application have identified at least the following technical problems in the convention:

As the user performs an entry operation on the N target objects with the same hand as the single holding hand, there is a significant distance from one end of the N target objects to a finger for a touch control operation, thus making it inconvenient for the user to perform the operation so that it may take a long period of time to perform a proper operation or the user may directly perform an improper operation, and consequently it may be time-consuming for the electronic device to receive the entry operation and the electronic device may respond to the improper operation.

### SUMMARY OF THE INVENTION

Embodiments of the invention provide an information processing method and an electronic device so as to address the technical problems in the convention that it may be time-consuming for the electronic device to receive an entry operation and the electronic device may respond to an improper operation.

According to a first aspect of the invention, there is provided an information processing method, applicable to an electronic device with a display unit on which there are displayed N target objects, wherein N is a positive integer, there is a display parameter for each of the target objects, there is an initial value for the display parameter of each of the target objects, and the display parameter is configured to determine a display size of the target object, the method including: determining M target objects and K target objects among the N target objects according to a preset rule, wherein M and K are positive integers less than or equal to N; detecting first parameter information of the electronic device; determining first values of the display parameters of the M target objects and second values of the display parameters of the K target objects based upon the first parameter information, wherein the first values are greater than the initial values and the second values are less than the initial values, or the first values are less than the initial values and the second values are greater than initial values; displaying the M target objects according to the display parameters of the first values; and displaying the K target objects according to the display parameters of the second values, so that the display sizes of the K target objects are different from the display sizes of the M target objects.

In connection with the first aspect, in a first possible implementation, before the displaying the M target objects according to the display parameters of the first values, the method further includes: detecting a first operation; and judging whether the first operation satisfies a preset condition; and the displaying the M target objects according to the display parameters of the first values includes: displaying the M target objects according to the display parameters of the first values when the first operation satisfies the preset condition.

In connection with the first aspect, in a second possible implementation, the detecting the first parameter information of the electronic device includes: detecting a posture of the electronic device to obtain a posture parameter which is the first parameter information; or detecting by a holding pattern touch control information on a first component on the electronic device, wherein the touch control information is the first parameter information, and the touch control information can characterize a holding pattern in which a user holds the electronic device; or detecting setting parameters of the electronic device for the N target objects, wherein the setting parameters are the first parameter information.

In connection with the second possible implementation of the first aspect, in a third possible implementation, the holding pattern is particularly a right-hand holding pattern of being held in the right hand or a left-hand holding pattern of being held in the left hand.

In connection with the third possible implementation of the first aspect, in a fourth possible implementation, the detecting the posture of the electronic device to obtain the posture parameter includes: detecting the posture parameter by an acceleration sensor arranged inside the electronic device, wherein the posture parameter is particularly a parameter to characterize an inclination direction of the electronic device or the posture parameter is particularly a parameter to characterize an inclination angle of the electronic device.

In connection with the fourth possible implementation of the first aspect, in a fifth possible implementation, the determining the first values of the display parameters of the M target objects and the second values of the display parameters of the K target objects based upon the first parameter information includes: determining the first values and the second values based upon the inclination direction; or determining the first values and the second values based upon the inclination angle; or determining the first values and the second values based upon the holding pattern.

In connection with the fifth possible implementation of the first aspect, in a sixth possible implementation, the determining the M target objects and the K target objects among the N target objects includes: determining the M target objects at a distance from the left side of a display interface of the electronic device being less than a first threshold among the N target objects; and determining the K target objects at a distance from the right side of the display interface of the electronic device being less than a second threshold among the N target objects.

In connection with the sixth possible implementation of the first aspect, in a seventh possible implementation, the determining the first values and the second values based upon the inclination direction includes: determining the first values greater than the initial values and the second values less than the initial values when the inclination direction is particularly the direction of inclination from the left to the right; and determining the first values less than the initial values and the second values greater than the initial values when the inclination direction is particularly the direction of inclination from the right to the left.

In connection with the sixth possible implementation of the first aspect, in an eighth possible implementation, the determining the first values and the second values based upon the inclination angle includes: determining absolute values of the differences between the first values and the second values based upon the inclination angle, wherein the absolute values of the differences are positively correlated to the inclination angle; and determining the first values and the second values based upon the absolute values of the differences.

In connection with the sixth possible implementation of the first aspect, in a ninth possible implementation, the determining the first values and the second values based upon the holding pattern includes: determining the first values greater than the initial values and the second values less than the initial values when the holding pattern is the right-hand handing pattern; and determining the first values less than the initial values and the second values greater than the initial values when the holding pattern is the left-hand handing pattern.

In connection with the first aspect or any of the first to ninth possible implementations of the first aspect, in a tenth possible implementation, the detecting the posture of the electronic device to obtain the posture parameter includes: detecting the first parameter information per preset interval of time; or detecting the first parameter information upon detection of invoking of the N target objects by the electronic device.

According to a second aspect of the invention, there is provided an electronic device with a display unit on which there are displayed N target objects, wherein N is a positive integer, there is a display parameter for each of the target objects, there is an initial value for the display parameter of each of the target objects, and the display parameter is configured to determine a display size of the target object, wherein the electronic device further includes: a first determination module configured to determine M target objects and K target objects among the N target objects according to a preset rule, wherein M and K are positive integers less than or equal to N; a first detection module configured to detect first parameter information of the electronic device; a second determination module configured to determine first values of the display parameters of the M target objects and second values of the display parameters of the K target objects based upon the first parameter information, wherein the first values are greater than the initial values and the second values are less than the initial values, or the first values are less than the initial values and the second values are greater than initial values; a first display module configured to display the M target objects according to the display parameters of the first values; and a second display module configured to display the K target objects according to the display parameters of the second values, so that the display sizes of the K target objects are different from the display sizes of the M target objects.

In connection with the second aspect, in a first possible implementation, the electronic device further includes: a second detection module configured to detect a first operation before the M target objects are displayed according to the display parameters of the first values; and a judgment module configured to judge whether the first operation satisfies a preset condition; and the first display module is further configured to display the M target objects according to the display parameters of the first values when the first operation satisfies the preset condition.

In connection with the second aspect, in a second possible implementation, the first detection module is further configured: to detect a posture of the electronic device to obtain a posture parameter which is the first parameter information; or to detect touch control information on a first component on the electronic device, wherein the touch control information is the first parameter information, and the touch control information can characterize a holding pattern in which a user holds the electronic device; or to detect setting parameters of the electronic device for the N target objects, wherein the setting parameters are the first parameter information.

In connection with the second possible implementation of the second aspect, in a third possible implementation, the holding pattern is particularly a right-hand holding pattern of being held in the right hand or a left-hand holding pattern of being held in the left hand.

In connection with the third possible implementation of the second aspect, in a fourth possible implementation, the first detection unit is further configured to detect the posture parameter by an acceleration sensor arranged inside the electronic device, wherein the posture parameter is particularly a parameter to characterize an inclination direction of the electronic device or the posture parameter is particularly a parameter to characterize an inclination angle of the electronic device.

In connection with the fourth possible implementation of the second aspect, in a fifth possible implementation, the second determination module is further configured: to determine the first values and the second values based upon the inclination direction; or to determine the first values and the second values based upon the inclination angle; or to determine the first values and the second values based upon the holding pattern.

In connection with the fifth possible implementation of the second aspect, in a sixth possible implementation, the first determination module is further configured: to determine the M target objects at a distance from the left side of a display interface of the electronic device being less than a first threshold among the N target objects; and to determine the K target objects at a distance from the right side of the display interface of the electronic device being less than a second threshold among the N target objects.

In connection with the sixth possible implementation of the second aspect, in a seventh possible implementation, the second determination module is further configured: to determine the first values greater than the initial values and the second values less than the initial values when the inclination direction is particularly the direction of inclination from the left to the right; and to determine the first values less than the initial values and the second values greater than the initial values when the inclination direction is particularly the direction of inclination from the right to the left.

In connection with the sixth possible implementation of the second aspect, in an eighth possible implementation, the second determination module further includes: a first determination unit configured to determine absolute values of the differences between the first values and the second values based upon the inclination angle, wherein the absolute values of the differences are positively correlated to the inclination angle; and a second determination unit configured to determine the first values and the second values based upon the absolute values of the differences.

In connection with the sixth possible implementation of the second aspect, in a ninth possible implementation, the second determination unit is further configured: to determine the first values greater than the initial values and the second values less than the initial values when the holding pattern is the right-hand handing pattern; and to determine the first values less than the initial values and the second values greater than the initial values when the holding pattern is the left-hand handing pattern.

In connection with the second aspect or any of the first to ninth possible implementations of the second aspect, in a tenth possible implementation, the first detection module is further configured: to detect the first parameter information per preset interval of time; or to detect the first parameter information upon detection of invoking of the N target objects by the electronic device.

Advantageous effects of the invention are as follows:

Since in the embodiments of the invention, a parameter of an electronic device can be detected, and first values of display parameters of M target objects among N target objects and second values, different from the first values, of display parameters of K target objects among N target objects displayed by a display unit of the electronic device can be determined, and further display sizes of the M target objects can be made different from those of the K target objects, and one of the first values and the second values are greater than initial values and the other are less than the initial values, so the most appropriate display parameters of the N target objects can be determined according to a different posture of the electronic device to thereby make it more convenient for a user to operate for the purpose of achieving technical effects of shortening a period of time consumed for the electronic device to receive an entry operation, and lowering the number of times that the electronic device may respond to an improper entry operation; and

Furthermore since the first values are greater than the initial values and the second values are less than the initial values; or the first values are less than the initial values and the second values are greater than the initial values, the display sizes of the N target objects will not be increased or decreased at the same time, to thereby achieve a technical effect of ensuring a constant display frame of the N target objects as a whole and further prevent some of the N target objects from failing to be displayed because a too large display area is occupied by the N target objects but there is a limited size of the display unit of the electronic device; and also prevent the technical problem of making it inconvenient for the user to operate due to too small display sizes of the N target objects.

### BRIEF DESCRIPTION OF THE DRAWINGS

FIG. 1 is a flow chart of an information processing method according to an embodiment of the invention;

FIG. 2a is a schematic diagram of a dialing keypad of a handset in the information processing method according to the embodiment of the invention;

FIG. 2b is a schematic diagram of the dialing keypad of the handset inclined from the right to the left in the information processing method according to the embodiment of the invention;

FIG. 2c is a schematic diagram of the dialing keypad of the handset inclined from the left to the right in the information processing method according to the embodiment of the invention;

FIG. 3a is a schematic diagram of an application icon interface of a tablet computer according to a second embodiment of the invention;

FIG. 3b is a schematic diagram of the application icon interface of the tablet computer held by a user in his or her right hand according to the embodiment of the invention;

FIG. 3c is a schematic diagram of the application icon interface of the tablet computer held by the user in his or her left hand according to the embodiment of the invention; and

FIG. 4 is a structural diagram of an electronic device according to an embodiment of the invention.

### DETAILED DESCRIPTION OF THE INVENTION

Embodiments of the invention provide an information processing method and an electronic device so as to address the technical problems in the convention that it may be time-consuming for the electronic device to receive an entry operation and the electronic device may respond to an improper operation.

In order to address the foregoing technical problems, a general idea of technical solutions according to the embodiments of the invention is as follows:

There is provided an information processing method, applicable to an electronic device with a display unit on which there are displayed N target objects, where N is a positive integer, there is a display parameter for each of the target objects, there is an initial value for the display parameter of each of the target objects, and the display parameter is configured to determine a display size of the target object, the method including: determining M target objects and K target objects among the N target objects according to a preset rule, where M and K are positive integers less than or equal to N; detecting first parameter information of the electronic device; determining first values of the display parameters of the M target objects and second values of the display parameters of the K target objects based upon the first parameter information, where the first values are greater than the initial values and the second values are less than the initial values, or the first values are less than the initial values and the second values are greater than initial values; displaying the M target objects according to the display parameters of the first values; and displaying the K target objects according to the display parameters of the second values, so that the display sizes of the K target objects are different from the display sizes of the M target objects.

Since in the foregoing solution, the most appropriate display parameters of the N target objects can be determined according to a different posture of the electronic device to thereby make it more convenient for a user to operate for the purpose of achieving technical effects of shortening a period of time consumed for the electronic device to receive an entry operation and lowering the number of times that the electronic device may respond to an improper entry operation.

In order to make the foregoing technical solution more apparent, the technical solution of the invention will be detailed below with reference to the drawings and particular embodiments thereof, and it shall be appreciated that the embodiments of the invention and particular features in the embodiments relate to a detailed description of the technical solution of the invention but are not intended to limit the technical solution of the invention, and the embodiments of the invention and the particular features in the embodiments can be combined with each other unless there is any collision.

In an aspect, there is provided according to an embodiment of the invention an information processing method, applicable to an electronic device with a display unit on which there are displayed N target objects, where N is a positive integer, and the electronic device is, for example, a tablet computer, a handset, etc.; and the N target objects are, for example, N dialing keys in a dialing interface of the handset, N entry keys in a virtual entry keypad of the electronic device, N application icons corresponding to an application icon interface on the electronic device, where there is a display parameter for the each target object, there is an initial value for the display parameter of each of the target objects, and the display parameter is configured to determine a display size of the target object.

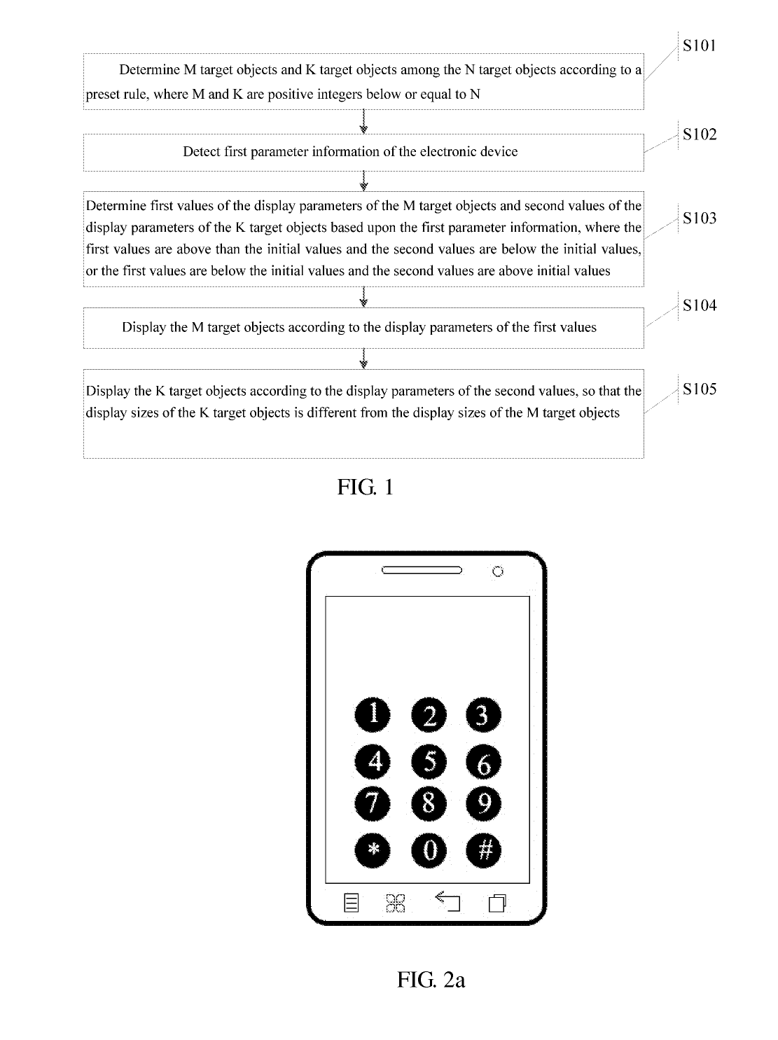

Referring to FIG. 1, the information processing method includes the following steps:

The step S101 is to determine M target objects and K target objects among the N target objects according to a preset rule, where M and K are positive integers less than or equal to N;

The step S102 is to detect first parameter information of the electronic device;

The step S103 is to determine first values of the display parameters of the M target objects and second values of the display parameters of the K target objects based upon the first parameter information, where the first values are greater than the initial values and the second values are less than the initial values, or the first values are less than the initial values and the second values are greater than initial values;

The step S104 is to display the M target objects according to the display parameters of the first values; and

The step S105 is to display the K target objects according to the display parameters of the second values, so that the display sizes of the K target objects is different from the display sizes of the M target objects.

Furthermore the M target objects and the K target objects are determined in the step S101 particularly in the following steps:

The M target objects at a distance from the left side of a display interface of the electronic device being less than a first threshold are determined among the N target objects; and

The K target objects at a distance from the right side of the display interface of the electronic device being less than a second threshold are determined among the N target objects.

In a particular implementation, the first threshold and the second threshold can be any values which are the same or different and can be embodied variously, for example, embodied as a physical distance, e.g., 1 cm, 2 cm, etc., for example, target objects at a distance from the left side of the display unit being less than 1 cm are determined as the M target object, and target objects at a distance from the right side of the display unit being less than 1 cm are determined as the K target object; in another example, embodied as a number of columns of a target object, e.g., 1 column, 2 columns, etc., for example, target objects at a distance from the left side of the display unit being less than 1 column are determined as the M target object, and target objects at a distance from the right side of the display unit being less than 1 column are determined as the K target object; in still another example, embodied as a distance in pixels, e.g., 100 pixels, 200 pixels, etc., and the embodiment of the invention will not be limited thereto.

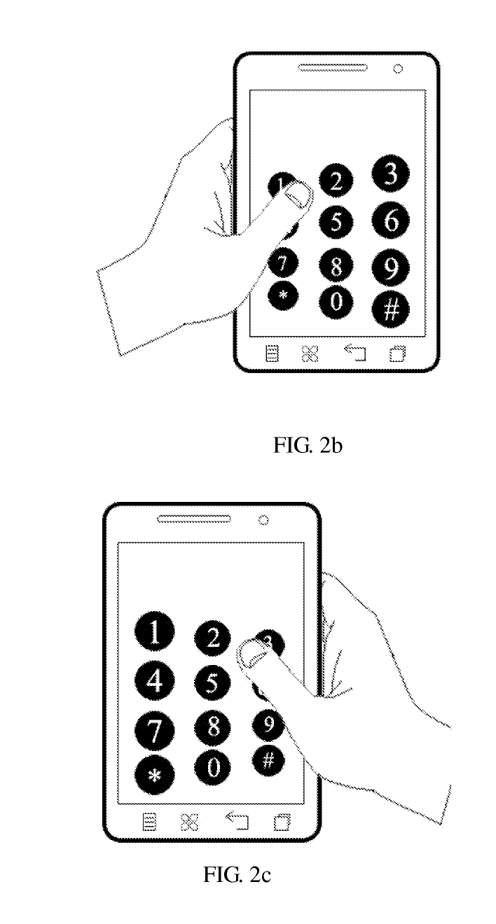

As illustrated in FIG. 2a, there is a schematic diagram of a dialing keypad of a handset by default, where 4 target objects on the dialing keypad at a distance from the left side of the handset being less than 1 column are determined as the M target objects, which are target objects “1”, “4”, “7” and “*”; and 4 target objects on the dialing keypad at a distance from the right side of the handset being less than 1 column are determined as the K target objects, which are target objects “3”, “6”, “9” and “#”.

Furthermore, the first parameter information can be obtained in the step S102 at numerous occasions, two of which will be listed below, and of course a particular implementation will not be limited to the following two scenarios.

Firstly, the first parameter information is detected per preset interval of time.

The preset interval of time can be any interval of time, e.g., 30 seconds, 1 minute, etc., and the embodiment of the invention will not be limited thereto. After the first parameter information is detected, the first values of the display parameters of the M target objects and the second values of the display parameters of the K target objects can be determined again, that is, the display sizes of the M target objects and the K target objects among the N target object can be adjusted per preset interval of time, for example, if a user accessing the electronic device changes a posture parameter of the electronic device, then the display parameters of the M target objects can again be adjusted to the most appropriate first values for the current posture of the electronic device, and the display parameters of the K target objects can also be adjusted to the most appropriate second values for the current posture of the electronic device for the purpose of controlling the display parameter of each of the N target objects more precisely to thereby make it more convenient to receive an entry operation by the user, thus further achieving technical effects of shortening a period of time consumed for the electronic device to receive the entry operation and lowering the number of times that the electronic device may respond to an improper entry operation.

Secondly, the first parameter information is detected upon detection of invoking of the N target objects by the electronic device.

Specifically, that is, the first parameter information will be detected only upon detection of an operation by a user to invoke the N target objects, and the display parameter of each of the N target objects can be further determined, thus achieving a technical effect of saving power consumption because it is not necessary to detect the first parameter information for a plurality of times.

In a particular implementation, the first parameter information in numerous forms can be detected in the step S102, three of which will be listed below, and of course a particular implementation will not be limited to the following three scenarios.

Firstly, the first parameter information of the electronic device is detected particularly as follows:

A posture of the electronic device is detected to obtain a posture parameter which is the first parameter information.

In a particular implementation, the posture parameter can be detected as follows:

The posture parameter is detected by an accelerator sensor arranged inside the electronic device.

In a particular implementation, the posture parameter can be embodied as numerous parameters, two of which will be listed below, and of course a particular implementation will not be limited to the following two parameters, and furthermore the posture parameter can be a combination of the following two parameters.

(1) The posture parameter is particularly a parameter to characterize an inclination direction of the electronic device;

In a particular implementation, the inclination direction is, for example, an inclination direction from the left to the right, an inclination direction from the right to the left, etc.

(2) The posture parameter is particularly a parameter to characterize an inclination angle of the electronic device;

In a particular implementation, the inclination angle can be any angle, e.g., 20 degrees, 30 degrees, 50 degrees, etc., and the embodiment of the invention will not be limited thereto.

Secondly, the first parameter information of the electronic device is detected particularly by detecting touch control information on a first component of the electronic device, where the touch control information is the first parameter information, and the touch control information can characterize a holding pattern in which the user holds the electronic device.

In a particular implementation, the first component is, for example, a housing of the electronic device or a touch control display unit of the electronic device, where the touch control information can be determined by a touch detection dot-matrix arranged on the housing or the touch control display unit, or the touch control information can be acquired by a camera arranged on the electronic device, and the holding pattern in which the user holds the electronic device can be determined from the touch control information.

Thirdly, the first parameter information of the electronic device is detected particularly by detecting setting parameters of the electronic device for the N target objects, where the setting parameters are the first parameter information.

In a particular implementation, a setting interface can be provided on the electronic device for the N target objects, and then corresponding setting parameters can be set respectively for the N target objects as the first parameter information. In a particular implementation, the initial values can be embodied in at least two scenarios, each of which will be listed below, and of course a particular implementation will not be limited to the following two scenarios.

Firstly, for R target objects among the N target objects other than the M target objects and the K target objects, the display parameters of the R target objects will be the initial values instead of being changed regardless of how the first parameter information of the electronic device may change; and

Secondly, the display parameters of the M target objects and the K target objects will be the initial values when the display parameters of the M target objects or the display parameters of the K target objects are not determined from any parameter of the electronic device.

Where the first values and the second values determined in the step S103 can be embodied in numerous scenarios, two of which will be listed below, and of course a particular implementation will not be limited to the following two scenarios.

Firstly the first values are greater than the initial values and the second values are less than the initial values.

Taking the N target objects which are dialing keys of a handset again as an example, referring to FIG. 2b, among 12 target objects of the dialing keys, display parameters of “2”, “5”, “8” and “#” are the initial values; display parameters of “1”, “4”, “7” and “*” are the first values greater than the initial values; and display parameters of “3”, “6”, “9” and “#” are the second values less than the initial values.

Secondly, the first values are less than the initial values and the second values are greater than the initial values. As illustrated in FIG. 5c, among the 12 target objects of the dialing keys, display parameters of “2”, “5”, “8” and “#” are the initial values; display parameters of “1”, “4”, “7” and “*” are the first values less than the initial values; and display parameters of “3”, “6”, “9” and “#” are the second values greater than the initial values.

As can be apparent from the foregoing description, since in the embodiment of the invention, the first values are greater than the initial values and the second values are less than the initial values; or the first values are less than the initial values and the second values are greater than the initial values, all the display sizes of the N target objects will not be increased or decreased at the same time, to thereby achieve a technical effect of ensuring a constant display frame of the N target objects as a whole and further prevent some of the N target objects from failing to be displayed because a too large display area is occupied by the N target objects but there is a limited size of the display unit of the electronic device; and also prevent the technical problem of making it inconvenient for the user to operate due to too small display sizes of the N target objects.

Furthermore, the first values and the second values can be determined in the step S103 in numerous ways, three of which will be listed below, and of course a particular implementation will not be limited thereto.

Firstly, the first values and the second values are determined based upon the inclination direction.

Specifically, the following steps may be further included: the first values greater than the initial values and the second values less than the initial values are determined when the inclination direction is particularly the direction of inclination from the left to the right; and

The first values less than the initial values and the second values greater than the initial values are determined when the inclination direction is particularly the direction of inclination from the right to the left.

In a particular implementation, in order to prevent the electronic device from slipping from their hands, the majority of users accessing the electronic device typically will control the electronic device to be inclined from the left to the right if they hold the electronic device in their right hands, so the electronic device being inclined from the left to the right can indicate the electronic device being held by the users in their right hands, which thus means that a plurality of target objects on the left side of the electronic device do not tend to be touched by the users, and the M target objects determined in the step S101 are target objects at a distance from the left side of the display unit being less than the first threshold, so the display parameters of the M target objects need to be set large, and the display parameters of the K target objects need to be set small, that is, the first values are greater than the initial values and the second values are less than the initial values.

For example, if the initial values are 20 pixels*20 pixels, then the first values are, for example, 25 pixels*25 pixels, and the second values are, for example, 15 pixels*15 pixels, and in a particular implementation, the first values (the second values) can be a single value, that is, the display size of each of the M target objects (the K target objects) may be the same, or the first values (the second values) can be a plurality of values, that is, the display size of each of the M target objects (the K target objects) may be different, and the embodiment of the invention will not be limited thereto.

As can be apparent from the foregoing description, since in the embodiment of the invention, when the posture parameter characterizes the inclination direction of the electronic device as the direction of from the right to the left, the first values of the display parameters of the M target objects at a distance from the left side of the display unit of the electronic device being less than the first threshold are controlled less than the initial values, and the second values of the display parameters of the K target objects at a distance from the right side of the display unit being less than the second threshold are controlled greater than the initial values; and when the posture parameter characterizes the inclination direction of the electronic device as the direction of from the left to the right, the first values are controlled greater than the initial values and the second values are controlled less than the initial values, thereby ensuring a technical effect of larger display sizes corresponding to the display parameters of the target objects in an area at a longer distance from the finger of the user of the electronic device to thereby ensure a proper operation to be performed by the user in a shorter period of time and hence lower the number of times that the electronic device may respond to an improper entry operation and improve a period of time for responding to an entry operation.

In a particular implementation, the first values and the second values can be display parameters characterizing in numerous forms, two of which will be listed below, and of course a particular implementation will not be limited to the following two scenarios.

(1) The first values and the second values are display parameters to characterize absolute display sizes of the N target objects or the M target objects, and taking the electronic device which is a handset again as an example, the N target objects are 12 keys corresponding to a dialing keypad of the handset, and a correspondence relationship between an absolute display size of each of the 12 keys and an inclination direction is stored in the electronic device, for example, as depicted in Table 1:

TABLE 1

| Inclination direction | Absolute display parameters |
|---|---|
| Inclination direction of from right to left | $\{ \begin{matrix}15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px\end{matrix} \}$ |
| Inclination direction of from left to right | $\{ \begin{matrix}25 px * 25 px & 20 px * 20 px & 15 px * 15 px \\ 25 px * 25 px & 20 px * 20 px & 15 px * 15 px \\ 25 px * 25 px & 20 px * 20 px & 15 px * 15 px \\ 25 px * 25 px & 20 px * 20 px & 15 px * 15 px\end{matrix} \}$ |

Furthermore, based upon the inclination direction of the electronic device, the absolute display size of each of the N target objects can be fetched directly from Table 1, and further the first values corresponding to the display parameters of the M target objects and the second values corresponding to the display parameters of the K target objects can be determined therefrom.

(2) The first values and the second values are display parameters to characterize relative display sizes of the N target objects or the M target objects, and taking the electronic device which is a handset again as an example, the N target objects are 12 keys corresponding to a dialing keypad of the handset, and a correspondence relationship between a relative display size of each of the N target objects and an inclination direction is stored in the handset, for example, as depicted in Table 2:

TABLE 2

| Inclination direction | Relative display parameters |
|---|---|
| Inclination direction of from right to left | $\{ \begin{matrix}- 1 & 0 & 1 \\ - 1 & 0 & 1 \\ - 1 & 0 & 1 \\ - 1 & 0 & 1\end{matrix} \}$ |
| Inclination direction of from left to right | $\{ \begin{matrix}1 & 0 & - 1 \\ 1 & 0 & - 1 \\ 1 & 0 & - 1 \\ 1 & 0 & - 1\end{matrix} \}$ |

Where −1 indicates that the display parameter is the initial value minus one step, 0 indicates the display parameter is the initial value, +1 indicates that the display parameter is the initial value plus one step, etc. For example, if the initial value is 20 pixels*20 pixels, and one step corresponds to 5 pixels*5 pixels, then the initial value minus one step is 15 pixels*15 pixels, and the initial value plus one step is 25 pixels*25 pixels.

Secondly the first values and the second values are determined based upon the inclination angle.

For example, absolute values of the differences between the first values and the second values are determined based upon the inclination angle, where the absolute values of the differences are positively correlated to the inclination angle; and

The first values and the second values are determined based upon the absolute values of the differences.

In a particular implementation, the absolute value of the difference particularly refers to that firstly the difference between the first value and the second value is made, and then the absolute value of the difference is taken, and in a particular implementation, the absolute value of the difference can be divided by 2 after the absolute value of the difference is determined to thereby derive the divided value, and if the first value or the second value is greater than the initial value, then the first value or the second value can be the initial value plus the divided value; and if the first value or the second value is less than the initial value, then the first value or the second value can be the initial value minus the divided value.

For example, if the absolute value of the difference is 10 pixels*10 pixels, and the initial value is 20 pixels*20 pixels, and the first value is greater than the initial value and the second value is less than the initial value, then firstly the absolute value of the difference is divided by 2 to derive the divided value of 5 pixels*5 pixels, and then the first value is the initial value plus the divided value as 25 pixels*25 pixels, and the second value is the initial value minus the divided value as 15 pixels*15 pixels; and if the first value is less than the second value, then the first value is the initial value minus the divided value as 15 pixels*15 pixels, and the second value is the initial value plus the divided value as 25 pixels*25 pixels. As can be apparent, the absolute value of the difference is for indicating the extent by which the first value is different from the second value, so a higher absolute value of the difference will indicates a higher extent by which the first value is different from the second value.

Furthermore, that is, the higher the inclination angle of the electronic device is, the higher the extent by which the first value is different from the second value will be.

In this scenario, the first values and the second values can also be determined in numerous ways, several of which will be listed below, and of course a particular implementation will not be limited to the following several scenarios.

Firstly, a correspondence relationship between an inclination angle and display parameters of all the N target objects is stored by default in the electronic device, and further the first values and the second values can be determined directly based upon the correspondence relationship, for example, as depicted in Table 3:

TABLE 3

| Inclination angle (in degrees) | Display parameters |
|---|---|
| 0~44 | $\{ \begin{matrix}- 1 & 0 & 1 \\ - 1 & 0 & 1 \\ - 1 & 0 & 1 \\ - 1 & 0 & 1\end{matrix} \}$ |
| 45~90 | $\{ \begin{matrix}- 2 & 0 & 2 \\ - 2 & 0 & 2 \\ - 2 & 0 & 2 \\ - 2 & 0 & 2\end{matrix} \}$ |

To determine the first values and the second values from Table 3 above, firstly the inclination angle of the electronic device is determined, for example, as 23 degrees, and since it lies between 0 and 44 degrees, the display parameters of the N target objects are determined as

$$\{ \begin{matrix}- 1 & 0 & 1 \\ - 1 & 0 & 1 \\ - 1 & 0 & 1 \\ - 1 & 0 & 1\end{matrix} \} ,$$

that is, the first values are the initial values minus one step, and the second values are the initial values plus one step, where “plus one step” and “minus one step” are similar those in Table 2, so a repeated description thereof will be omitted here. Furthermore the foregoing numerals are merely exemplary but not intended to be limiting.

Secondly, a calculation equation can be set in the electronic device as a correspondence relationship between an amount of change in display size and an inclination angle, for example, Y=1/10*X, where X represents the inclination angle, and Y represents the amount of change in display size, so this equation represents that the first values or the second values are changed by one step, which can be any preset value, for example, 1 pixel*1 pixel, 5 pixels*5 pixels, etc., as the inclination angle is incremented by 10 degrees, and the embodiment of the invention will not be limited thereto; and of course another preset equitation is possible in a particular implementation, and the embodiment of the invention will not be limited thereto.

As can be apparent from the foregoing description, since in the embodiment of the invention, the first values of the display parameters of the M target objects and the second values of the display parameters of the K target objects can be further determined from the inclination angle of the electronic device, for example, the higher the inclination angle, the higher the absolute values of the differences between the first values and the second values will be, thus achieving a technical effect of controlling the N target objects to be displayed more precisely.

Furthermore, since there is a limited size of the display interface of the electronic device, it may be inconvenient for the user to operate if the display sizes of the N target objects are too small, so in order to prevent the first values and the second values from being changed without any limitation, which may make it inconvenient for the user to operate and hence result in the technical problem of taking a long period of time for the electronic device to respond to a touch control operation or responding to an improper touch control operation, maximum values and minimum values can be set for the first values and the second values, and they will not be incremented any more when they are incremented to their maximum values or will not decremented any more when they are decremented to their minimum values. For example, if the maximum values are 40 pixels*40 pixels, and the minimum values are 5 pixels*5 pixels, and the initial values are 20 pixels*20 pixels again, and the display parameters are changed each time by one step which is 5 pixels*5 pixels, then given the inclination angle of 30 degrees, the amount in change in display size is 3 steps, so the display sizes reach the minimum display sizes of 5 pixels*5 pixels when the amount in change in display size becomes lower, and in this case, display sizes will not be decremented even if the inclination angle is incremented; and given the inclination angle of 40 degrees, the amount in change in display size is 4 steps, so the display sizes reach the maximum display sizes of 40 pixels*40 pixels when the amount in change in display size becomes higher, and thus the display sizes will not be incremented even if the inclination angle is incremented.

Thirdly, the first values and the second values are determined based upon the holding pattern. In a particular implementation, the holding pattern is, for example, a right-hand holding pattern of being held in the right hand or a left-hand holding pattern of being held in the left hand.

Where the first values greater than the initial values and the second less than the initial values are determined when the holding pattern is particularly the right-hand holding pattern; and the first values less than the initial values and the second greater than the initial values are determined when the holding pattern is particularly the left-hand holding pattern.

In a particular implementation, when the holding pattern is the right-hand holding pattern, the finger of the user is at a longer distance from the M target objects and at a shorter distance from the K target objects, so the first values of the M target objects need to be determined greater than the initial values, and the second values of the N target objects need to be determined less than the initial values; and when the holding pattern is the left-hand holding pattern, the finger of the user is at a shorter distance from the M target objects and at a longer distance from the K target objects, so the first values of the M target objects need to be determined less than the initial values, and the second values of the N target objects need to be determined greater than the initial values. Furthermore, before the M target objects are displayed according to the display parameters of the first values in the step S104, the method further includes:

A first operation is detected; and

It is judged whether the first operation satisfies a preset condition.

In a particular implementation, the first operation can be any preset operation, for example, an operation to generate a sliding gesture on the display unit of the electronic device, an operation to hold the electronic device in the hand of the user, etc., and the embodiment of the invention will not be limited thereto.

Furthermore, the M target objects are displayed according to the display parameters of the first values particularly as follows:

The M target objects are displayed according to the display parameters of the first values when the first operation satisfies the preset condition.

Specifically, stated otherwise, the M target objects and the N target objects will be displayed in different display sizes only if there is a trigger condition to thereby achieve a technical effect of controlling the N target objects to be displayed more precisely and hence improve an experience of the user.

The information processing method of the invention will be described below in several particular embodiments, and the following embodiments generally relate to possible implementations of the information processing method. It shall be noted that the embodiments of the invention are merely intended to illustrate the invention but not to limit the invention. All of embodiments consistent with the inventive idea shall come into the scope of the invention, and of course those skilled in the art can appreciate numerous variations thereof without departing from the spirit of the invention.

### First Embodiment

This embodiment will be described taking as an example the electronic device which is a handset on which there is arranged a gravity sensor.

A correspondence relationship as depicted in Table 4 between an inclination direction, an inclination angle and display parameters of the N target objects is stored in the handset, that is, the display parameters of the N target objects can only be determined from inclination direction and the inclination angle together, and the first values of the M target objects and the second values of the K target objects can be further determined.

TABLE 4

| Inclination | Inclination angle | |
|---|---|---|
| direction | (in degrees) | Relative display parameters |
| Inclination direction of from right to left | 0~44 | $\{ \begin{matrix}- 1 & 0 & 1 \\ - 1 & 0 & 1 \\ - 1 & 0 & 1 \\ - 1 & 0 & 1\end{matrix} \}$ |
| | 45~90 | $\{ \begin{matrix}- 2 & 0 & 2 \\ - 2 & 0 & 2 \\ - 2 & 0 & 2 \\ - 2 & 0 & 2\end{matrix} \}$ |
| Inclination direction of from left to right | 0~44 | $\{ \begin{matrix}1 & 0 & - 1 \\ 1 & 0 & - 1 \\ 1 & 0 & - 1 \\ 1 & 0 & - 1\end{matrix} \}$ |
| | 45~90 | $\{ \begin{matrix}2 & 0 & - 2 \\ 2 & 0 & - 2 \\ 2 & 0 & - 2 \\ 2 & 0 & - 2\end{matrix} \}$ |

At an instance of time T1, a user A of the handset wants to power on the handset to dial a telephone number, thus resulting in an operation to invoke a dialing keypad of the handset, which includes 12 keys which are the N target objects described above;

After the operation is detected by the handset, an inclination direction of the handset is detected by the gravity sensor as the inclination direction of from the right to the left, and also an inclination angle of the handset is detected by the gravity sensor as 33 degrees;

Furthermore, display parameters of the respective keys in the dialing keypad are determined from Table 4 according to the inclination direction of from the right to the left and the inclination angle of 33 degrees are

$$\{ \begin{matrix}- 1 & 0 & 1 \\ - 1 & 0 & 1 \\ - 1 & 0 & 1 \\ - 1 & 0 & 1\end{matrix} \} ,$$

that is, the first values are

$$\{ \begin{matrix}- 1 \\ - 1 \\ - 1 \\ - 1\end{matrix} \} ,$$

and the second values are

$$\{ \begin{matrix}1 \\ 1 \\ 1 \\ 1\end{matrix} \} ;$$

and specifically the keys “1”, “3”, “7” and “*” are the M target objects described above, so their display parameters are

$$\{ \begin{matrix}- 1 \\ - 1 \\ - 1 \\ - 1\end{matrix} \} ,$$

and the keys “3”, “6”, “9” and “#” are the K target objects described above, so their display parameters are

$$\{ \begin{matrix}1 \\ 1 \\ 1 \\ 1\end{matrix} \} ;$$

and furthermore display sizes of the keys “1”, “3”, “7” and “*” are determined as the initial values minus one display step, where again as an example, the initial values are 20 pixels*20 pixels and one display step corresponds to 5 pixels*5 pixels, so the first values of these four keys are determined as 15 pixels*15 pixels; and display sizes of the keys “3”, “6”, “9” and “#” are determined as the default display size plus one display step, and further the second values of these four keys are determined as 25 pixels*25 pixels; and the keys “2”, “5”, “8” and “0” are displayed in the initial sizes, and the following absolute display size of each of the N target objects is further determined:

$$\{ \begin{matrix}15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px\end{matrix} \} ;$$

and

Finally, the handset displays the dialing keypad on the display unit of the handset in the foregoing absolute display sizes for the user to perform a dialing operation.

### Second Embodiment

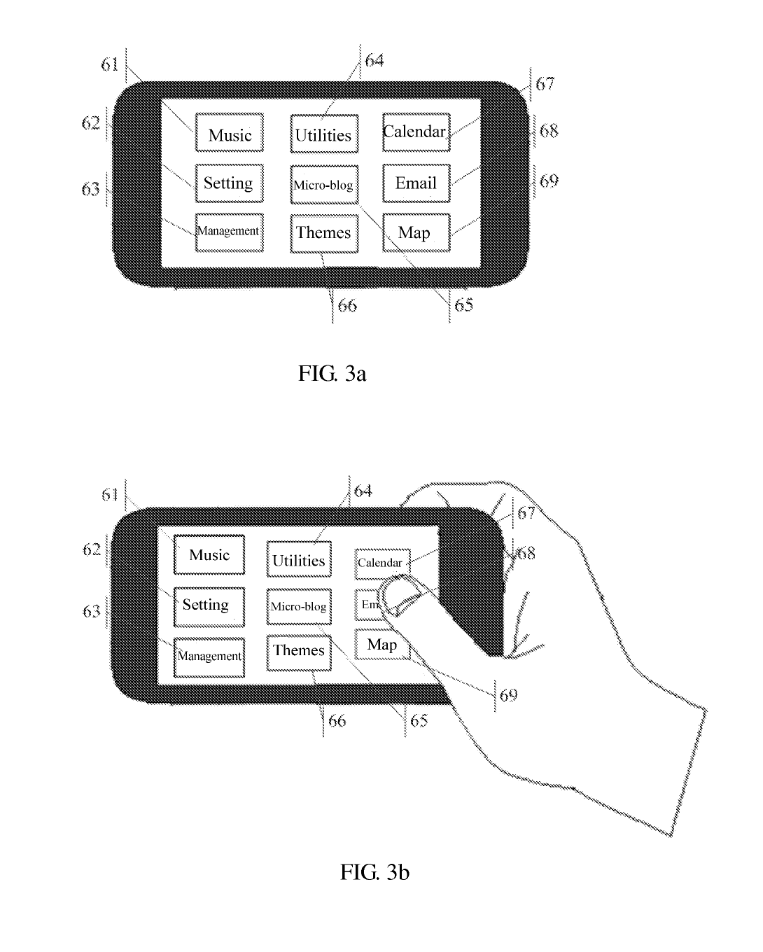

This embodiment will be described taking as an example the electronic device which is a tablet computer on which there are 9 application icons corresponding to an application icon interface, as illustrated in FIG. 3a which is by default a schematic diagram of displaying these 9 application icons, which are a music icon 61, a setting icon 62, a management icon 63, an utility icon 64, a micro-blog icon 65, a theme icon 66, a calendar icon 67, an email icon 68 and a map icon 69 respectively, and as illustrated in FIG. 6a showing a default condition, there is a schematic diagram of a display interface of these application icons, where the music icon 61, the setting icon 62 and the management icon 63 among these application icons are the M target objects described above, and the calendar icon 67, the email icon 68 and the map icon 69 are the N target objects described above.

Absolute display parameters as depicted in Table 5 are stored in the tablet computer.

TABLE 5

| Holding pattern | Absolute display parameters |
|---|---|
| Left-hand holding pattern | $\{ \begin{matrix}15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px\end{matrix} \}$ |
| Right-hand holding pattern | $\{ \begin{matrix}25 px * 25 px & 20 px * 20 px & 15 px * 15 px \\ 25 px * 25 px & 20 px * 20 px & 15 px * 15 px \\ 25 px * 25 px & 20 px * 20 px & 15 px * 15 px \\ 25 px * 25 px & 20 px * 20 px & 15 px * 15 px\end{matrix} \}$ |

There is a camera arranged on the tablet computer, and the camera acquires a holding pattern by the user per 30 seconds and further determines the display parameters of the M application icons, the N application icons and the remaining R application icons respectively;

At an instance of time T2, the pattern in which the user holds the tablet computer is detected by the camera arranged in the tablet computer as the right-hand holding pattern, and the following absolute display parameters are further determined from the correspondence relationship as depicted in Table 5:

$$\{ \begin{matrix}25 px * 25 px & 20 px * 20 px & 15 px * 15 px \\ 25 px * 25 px & 20 px * 20 px & 15 px * 15 px \\ 25 px * 25 px & 20 px * 20 px & 15 px * 15 px \\ 25 px * 25 px & 20 px * 20 px & 15 px * 15 px\end{matrix} \} ;$$

That is, these 9 application icons are displayed, where the first values of the display parameters of the music icon 61, the setting icon 62 and the management icon 63 are greater than the second values of the display parameters of the calendar icon 67, the email icon 68 and the map icon 69, and the display parameters of the utility icon 64, the micro-blog icon 65 and the theme icon 66 are initial values;

At an instance of time T3, a user of the tablet computer generates an operation to display the application icon interface, and the tablet computer determines these 9 application icons to be displayed on the display interface of the tablet computer upon detection of the operation, and since it has been determined at the instance of time T2 that the first values are greater than the initial values and the second values are less than the initial values, these 9 application icons are displayed on the tablet computer in the pattern as illustrated in FIG. 3b;

At an instance of time T4, the user of the tablet computer feels tired of holding the tablet computer in his or her right hand and hence changes to hold the tablet computer in his or her left hand;

At an instance of time T5 subsequent to the instance of time T4, the camera detects again touch control information by the user of the table computer on a housing of the table computer and further determines the holding patter as the right-hand holding pattern and further determines the absolute display parameters illustrated below from

TABLE 5
$\{ \begin{matrix}15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px \\ 15 px * 15 px & 20 px * 20 px & 25 px * 25 px\end{matrix} \} .$

That is, these 9 application icons are displayed in the pattern where the first values are less than the initial values and the second values are greater than the initial values, as illustrated in FIG. 3c.

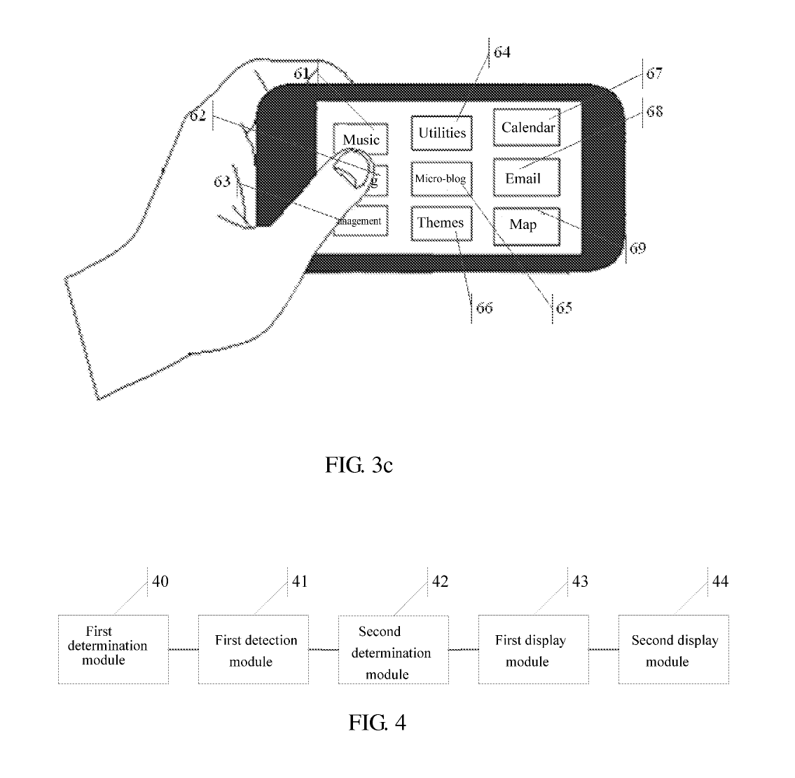

In another aspect, an embodiment of the invention provides an electronic device with a display unit on which there are displayed N target objects, where N is a positive integer, there is a display parameter for each of the target objects, there is an initial value for the display parameter of each of the target objects, and the display parameter is configured to determine a display size of the target object, and referring to FIG. 4, the electronic device further includes:

A first determination module 40 is configured to determine M target objects and K target objects among the N target objects according to a preset rule, where M and K are positive integers less than or equal to N;

A first detection module 41 is configured to detect first parameter information of the electronic device;

A second determination module 42 is configured to determine first values of the display parameters of the M target objects and second values of the display parameters of the K target objects based upon the first parameter information, where the first values are greater than the initial values and the second values are less than the initial values, or the first values are less than the initial values and the second values are greater than initial values;

A first display module 43 is configured to display the M target objects according to the display parameters of the first values; and

A second display module 44 is configured to display the K target objects according to the display parameters of the second values, so that the display sizes of the K target objects are different from the display sizes of the M target objects.

Optionally the electronic device further includes:

A second detection module is configured to detect a first operation before the M target objects are displayed according to the display parameters of the first values; and

A judgment module is configured to judge whether the first operation satisfies a preset condition; and

The first display module is further configured:

To display the M target objects according to the display parameters of the first values when the first operation satisfies the preset condition.

Optionally the first detection module 41 is further configured:

To detect a posture of the electronic device to obtain a posture parameter which is the first parameter information; or

To detect touch control information on a first component on the electronic device, where the touch control information is the first parameter information, and the touch control information can characterize a holding pattern in which a user holds the electronic device; or

To detect setting parameters of the electronic device for the N target objects, where the setting parameters are the first parameter information.

Optionally, the holding pattern is particularly a right-hand holding pattern of being held in the right hand or a left-hand holding pattern of being held in the left hand.

Optionally, the first detection unit 41 is further configured:

To detect the posture parameter by an acceleration sensor arranged inside the electronic device, where the posture parameter is particularly a parameter to characterize an inclination direction of the electronic device; or the posture parameter is particularly a parameter to characterize an inclination angle of the electronic device.

Optionally, the second determination module 42 is further configured:

To determine the first values and the second values based upon the inclination direction; or

To determine the first values and the second values based upon the inclination angle; or

To determine the first values and the second values based upon the holding pattern.

Optionally, the first determination module 40 is further configured:

To determine the M target objects at a distance from the left side of a display interface of the electronic device being less than a first threshold among the N target objects; and

To determine the K target objects at a distance from the right side of the display interface of the electronic device being less than a second threshold among the N target objects.

Optionally, the second determination module 42 is further configured:

To determine the first values greater than the initial values and the second values less than the initial values when the inclination direction is particularly the direction of inclination from the left to the right; and

To determine the first values less than the initial values and the second values greater than the initial values when the inclination direction is particularly the direction of inclination from the right to the left.

Optionally the second determination module 42 further comprises:

A first determination unit is configured to determine absolute values of the differences between the first values and the second values based upon the inclination angle, where the absolute values of the differences are positively correlated to the inclination angle; and

A second determination unit is configured to determine the first values and the second values based upon the absolute values of the differences.

Optionally, the second determination unit 42 is further configured:

To determine the first values greater than the initial values and the second values less than the initial values when the holding pattern is the right-hand handing pattern; and

To determine the first values less than the initial values and the second values greater than the initial values when the holding pattern is the left-hand handing pattern.

Optionally, the first detection module 41 is further configured:

To detect the first parameter information per preset interval of time; or

To detect the first parameter information upon detection of invoking of the N target objects by the electronic device.

Since the electronic device according to the embodiment of the invention corresponds to the information processing method according to the embodiment of the invention, those skilled in the art can appreciate from the information processing method according to the embodiment of the invention a general structure of the electronic device according to the embodiment of the invention and variations thereof, so a repeated description thereof will be omitted here.

One or more of the technical solutions according to this application have at least the following technical effects or advantages:

(1) Since in the embodiments of the invention, a parameter of an electronic device can be detected, and first values of display parameters of M target objects among N target objects and second values, different from the first values, of display parameters of K target objects among Displayed N target objects by a display unit of the electronic device can be determined, and further display sizes of the M target objects can be made different from those of the K target objects, and one of the first values and the second values are greater than initial values and the others are less than the initial values, so the most appropriate display parameters of the N target objects can be determined according to a different posture of the electronic device to thereby make it more convenient for a user to operate for the purpose of achieving technical effects of shortening a period of time consumed for the electronic device to receive an entry operation and lowering the number of times that the electronic device may respond to an improper entry operation; and

Furthermore since the first values are greater than the initial values and the second values are less than the initial values; or the first values are less than the initial values and the second values are greater than the initial values, all the display sizes of the N target objects will not be increased or decreased at the same time to thereby achieve a technical effect of ensuring a constant display frame of the N target objects as a whole and further prevent some of the N target objects from failing to be displayed because a too large display area is occupied by the N target objects but there is a limited size of the display unit of the electronic device; and also prevent the technical problem of making it inconvenient for the user to operate due to too small display sizes of the N target objects.

(2) Since in the embodiments of the invention, the first parameter information can be detected per preset interval of time, and the first display parameters of the N target objects can be further determined, that is, the display size of each of the N target objects can be adjusted per preset interval of time, for example, if the user accessing the N target objects changes the first parameter information, then the display sizes of the N target objects can also be adjusted to the most appropriate first display sizes for the current first parameter information for the purpose of controlling the first display parameters of the N target objects more precisely to thereby make it more convenient to receive an entry operation by the user, thus further achieving technical effects of shortening a period of time consumed for the electronic device to receive the entry operation and lowering the number of times that the electronic device may respond to an improper entry operation.

(3) Since in the embodiments of the invention, the first parameter information of the electronic device will be detected only upon detection of an operation by the user to invoke the N target objects, and the first values of the display parameters of the M target objects and the second values of the display parameters of the K target objects can be further determined, thus achieving a technical effect of saving power consumption because it is not necessary to detect the first parameter information for a plurality of times.

(4) Since in the embodiments of the invention, the first parameter information can be embodied as numerous first parameter information, for example, the posture parameter of the electronic device, the holding pattern of the user of the electronic device, the setting parameter for the N target objects, etc., to thereby achieve a technical effect of further diversifying control on the display of the N target objects.

(5) Since in the embodiments of the invention, when the posture parameter characterizes the inclination direction of the electronic device as the direction of from the right to the left, the first values of the display parameters of the M target objects at a distance from the left side of the display unit of the electronic device being less than the first threshold are controlled less than the initial values, and the second values of the display parameters of the K target objects at a distance from the right side of the display unit being less than the second threshold are controlled greater than the initial values; and when the posture parameter characterizes the inclination direction of the electronic device as the direction of from the left to the right, the first values are controlled greater than the initial values and the second values are controlled less than the initial values, thereby ensuring a technical effect of larger display sizes corresponding to the display parameters of the target objects in an area at a longer distance from the finger of the user of the electronic device to thereby ensure a proper operation to be performed by the user in a shorter period of time and hence lower the number of times that the electronic device may respond to an improper entry operation and improve a period of time for responding to an entry operation.

(6) Since in the embodiments of the invention, when the first parameter information is the inclination angle of the electronic device, the first values of the display parameters of the M target objects and the second values of the display parameters of the K target objects can be determined from the inclination angle, for example, the higher the inclination angle of the electronic device is, the larger the absolute values of the differences between the first values and the second values will be, thereby achieving a technical effect of controlling the N target objects to be displayed more precisely.

(7) Since in the embodiments of the invention, when the first parameter information is touch control information to characterize a holding pattern in which the user of the electronic device holds the electronic device, the sizes of the first values and the second values can be determined from the holding pattern being the left-hand holding pattern or the right-hand holding pattern, and since the finger of the user is at a longer distance from the K target objects in the left-hand holding pattern, the first values can be set less than the initial values and the second values can be set greater than the initial values; and since the finger of the user is at a longer distance from the M target objects in the right-hand holding pattern, the first values can be set greater than the initial values and the second values can be set less than the initial values to thereby prevent more accurately an improper response of the electronic device as a result of an improper operation performed by the user.

(8) Since in the embodiments of the invention, the M target objects and the N target objects will be displayed in different display sizes only if there is a trigger condition to thereby achieve a technical effect of controlling the N target objects to be displayed more precisely and hence improve an experience of the user.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore, the invention can be embodied in the form of a computer program product embodied in one or more computer useable storage mediums (including but not limited to a disk memory, a CD-ROM, an optical memory, etc.) in which computer usable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded into a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded into the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. An information processing method, applicable to an electronic device with a display unit on which there are displayed N target objects, wherein N is a positive integer, there is a display parameter for each of the target objects, there is an initial value for the display parameter of each of the target objects, and the display parameter is configured to determine a display size of the target object, wherein the method comprises:
determining M target objects and K target objects among the N target objects according to a preset rule, wherein M and K are positive integers less than or equal to N;
detecting first parameter information of the electronic device;
determining first values of the display parameters of the M target objects and second values of the display parameters of the K target objects based upon the first parameter information, wherein the first values are greater than the initial values and the second values are less than the initial values, or the first values are less than the initial values and the second values are greater than initial values;
displaying the M target objects according to the display parameters of the first values; and
displaying the K target objects according to the display parameters of the second values, so that the display sizes of the K target objects are different from the display sizes of the M target objects.

2. The method according to claim 1, wherein before the displaying the M target objects according to the display parameters of the first values, the method further comprises:
detecting a first operation; and
judging whether the first operation satisfies a preset condition; and
the displaying the M target objects according to the display parameters of the first values comprises:
displaying the M target objects according to the display parameters of the first values when the first operation satisfies the preset condition.

3. The method according to claim 1, wherein the detecting the first parameter information of the electronic device comprises:
detecting a posture of the electronic device to obtain a posture parameter which is the first parameter information; or
detecting touch control information on a first component on the electronic device, wherein the touch control information is the first parameter information, and the touch control information can characterize a holding pattern in which a user holds the electronic device; or
detecting setting parameters of the electronic device for the N target objects, wherein the setting parameters are the first parameter information.

4. The method according to claim 3, wherein the holding pattern is particularly a right-hand holding pattern of being held in the right hand or a left-hand holding pattern of being held in the left hand.

5. The method according to claim 4, wherein the detecting the posture of the electronic device to obtain the posture parameter comprises:
detecting the posture parameter by an acceleration sensor arranged inside the electronic device, wherein the posture parameter is particularly a parameter to characterize an inclination direction of the electronic device or the posture parameter is particularly a parameter to characterize an inclination angle of the electronic device.

6. The method according to claim 5, wherein the determining the first values of the display parameters of the M target objects and the second values of the display parameters of the K target objects based upon the first parameter information comprises:
determining the first values and the second values based upon the inclination direction; or
determining the first values and the second values based upon the inclination angle; or
determining the first values and the second values based upon the holding pattern.

7. The method according to claim 6, wherein the determining the M target objects and the K target objects among the N target objects comprises:
determining the M target objects at a distance from the left side of a display interface of the electronic device being less than a first threshold among the N target objects; and
determining the K target objects at a distance from the right side of the display interface of the electronic device being less than a second threshold among the N target objects.

8. The method according to claim 7, wherein the determining the first values and the second values based upon the inclination direction comprises:
determining the first values greater than the initial values and the second values less than the initial values when the inclination direction is particularly the direction of inclination from the left to the right; and
determining the first values less than the initial values and the second values greater than the initial values when the inclination direction is particularly the direction of inclination from the right to the left.

9. The method according to claim 7, wherein the determining the first values and the second values based upon the inclination angle comprises:
determining absolute values of the differences between the first values and the second values based upon the inclination angle, wherein the absolute values of the differences are positively correlated to the inclination angle; and
determining the first values and the second values based upon the absolute values of the differences.

10. The method according to claim 7, wherein the determining the first values and the second values based upon the holding pattern comprises:
determining the first values greater than the initial values and the second values less than the initial values when the holding pattern is the right-hand handing pattern; and
determining the first values less than the initial values and the second values greater than the initial values when the holding pattern is the left-hand handing pattern.

11. The method according to claim 1, wherein the detecting the posture of the electronic device to obtain the posture parameter comprises:
detecting the first parameter information per preset interval of time; or
detecting the first parameter information upon detection of invoking of the N target objects by the electronic device.

12. An electronic device with a display unit on which there are displayed N target objects, wherein N is a positive integer, there is a display parameter for each of the target objects, there is an initial value for the display parameter of each of the target objects, and the display parameter is configured to determine a display size of the target object, wherein the electronic device further comprises:
a first determination module configured to determine M target objects and K target objects among the N target objects according to a preset rule, wherein M and K are positive integers less than or equal to N;
a first detection module configured to detect first parameter information of the electronic device;
a second determination module configured to determine first values of the display parameters of the M target objects and second values of the display parameters of the K target objects based upon the first parameter information, wherein the first values are greater than the initial values and the second values are less than the initial values, or the first values are less than the initial values and the second values are greater than initial values;
a first display module configured to display the M target objects according to the display parameters of the first values; and
a second display module configured to display the K target objects according to the display parameters of the second values, so that the display sizes of the K target objects are different from the display sizes of the M target objects.

13. The electronic device according to claim 12, wherein the electronic device further comprises:
a second detection module configured to detect a first operation before the M target objects are displayed according to the display parameters of the first values; and
a judgment module configured to judge whether the first operation satisfies a preset condition; and
the first display module is further configured:
to display the M target objects according to the display parameters of the first values when the first operation satisfies the preset condition.

14. The electronic device according to claim 12, wherein the first detection module is further configured:
to detect a posture of the electronic device to obtain a posture parameter which is the first parameter information; or
to detect touch control information on a first component on the electronic device, wherein the touch control information is the first parameter information, and the touch control information can characterize a holding pattern in which a user holds the electronic device; or
to detect setting parameters of the electronic device for the N target objects, wherein the setting parameters are the first parameter information.

15. The electronic device according to claim 14, wherein the holding pattern is particularly a right-hand holding pattern of being held in the right hand or a left-hand holding pattern of being held in the left hand.

16. The electronic device according to claim 15, wherein the first detection unit is further configured:
to detect the posture parameter by an acceleration sensor arranged inside the electronic device, wherein the posture parameter is particularly a parameter to characterize an inclination direction of the electronic device or the posture parameter is particularly a parameter to characterize an inclination angle of the electronic device.

17. The electronic device according to claim 16, wherein the second determination module is further configured:
to determine the first values and the second values based upon the inclination direction; or
to determine the first values and the second values based upon the inclination angle; or
to determine the first values and the second values based upon the holding pattern.

18. The electronic device according to claim 17, wherein the first determination module is further configured:
to determine the M target objects at a distance from the left side of a display interface of the electronic device being less than a first threshold among the N target objects; and
to determine the K target objects at a distance from the right side of the display interface of the electronic device being less than a second threshold among the N target objects.

19. The electronic device according to claim 18, wherein the second determination module is further configured:
to determine the first values greater than the initial values and the second values less than the initial values when the inclination direction is particularly the direction of inclination from the left to the right; and
to determine the first values less than the initial values and the second values greater than the initial values when the inclination direction is particularly the direction of inclination from the right to the left.

20. The electronic device according to claim 18, wherein the second determination module further comprises:
a first determination unit configured to determine absolute values of the differences between the first values and the second values based upon the inclination angle, wherein the absolute values of the differences are positively correlated to the inclination angle; and
a second determination unit configured to determine the first values and the second values based upon the absolute values of the differences.
